(19) United States
(12) Patent Application Publication
(10) Pub. No.: US 2026/0075505 A1
(43) Pub. Date: Mar. 12, 2026

(54) PERSONAL IOT NETWORK INFORMATION UPDATING METHOD AND APPARATUS, COMMUNICATION DEVICE AND STORAGE MEDIUM

(71) Applicant: BEIJING XIAOMI MOBILE SOFTWARE CO., LTD., Beijing (CN)

(72) Inventor: Jianning LIU, Beijing (CN)

(21) Appl. No.: 19/102,295

(22) PCT Filed: Aug. 9, 2022
(86) PCT No.: PCT/CN2022/111280

§ 371 Date: Feb. 7, 2025

(51) Int. Cl. H04W 48/16; H04W 84/18

(52) U.S. Cl. CPC H04W 48/16; H04W 84/18

(57) ABSTRACT

A method for updating personal IoT network (PIN) information is executed by a first PIN element with management capability (PEMC). The method includes: determining that a predetermined event of a first PIN element (PINE) is triggered, and sending PIN update request information to a first network function, wherein the PIN update request information is configured to request to update PIN information.

### CROSS REFERENCE TO RELATED APPLICATIONS

The present application is a U.S. national phase of International Application No. PCT/CN2022/111280, filed on Aug. 9, 2022, the disclosure of which is incorporated herein by reference in its entirety.

### TECHNICAL FIELD

The present disclosure relates to but is not limited to the field of communication technologies, and in particular to methods and apparatuses for updating personal IoT network (PIN) information, a communication device and a storage medium.

### BACKGROUND

A PIN consists of PIN elements that communicate using a PIN direct connection or a direct network connection and is managed locally (for example, using a PIN element with management capability to manage). The PIN elements can be wearable devices, smart homes or smart office equipment. Via a PIN element with gateway capability, the PIN elements have access to network services and can communicate with PIN elements that are not within range to use the PIN direct connection. A PIN includes at least one PIN element with gateway capability and at least one PIN element with management capability. In the related art, how to update related parameters of the PIN is a problem that needs to be considered.

### SUMMARY

In view of this, embodiments of the present disclosure provide methods and apparatuses for updating personal IoT network (PIN) information, a communication device and a storage medium.

According to a first aspect of the present disclosure, there is provided a method for updating personal IoT network (PIN) information, executed by a first PIN element with management capability (PEMC), including: determining that a predetermined event of a first PIN element (PINE) is triggered, and sending PIN update request information to a first network function, where the PIN update request information is configured to request to update PIN information.

According to a second aspect of the present disclosure, there is provided a method for updating personal IoT network (PIN) information, executed by a first network function, including: receiving PIN update request information sent by a first PIN element with management capability (PEMC), where the PIN update request information is configured to request to update PIN information.

According to a third aspect of the present disclosure, there is provided a method for updating personal IoT network (PIN) information, executed by a second network function or a third network function, including: receiving PIN update request information sent by a first network function; and updating PIN information based on the PIN update request information.

According to a fourth aspect of the present disclosure, there is provided a communication device, including: one or more processors; and a memory for storing executable instructions of the one or more processors, where the one or more processors are configured to, when executing the executable instructions, implement the method described in any embodiment of the present disclosure.

According to a fifth aspect of an embodiment of the present disclosure, there is provided a computer storage medium storing computer executable programs which, when executed by a processor, implement the method described in any embodiment of the present disclosure.

In the embodiments of the present disclosure, it is determined that the predetermined event of the first PINE is triggered, and the PIN update request information is sent to the first network function, where the PIN update request information is configured to request to update PIN information. Here, since the PIN update request information for requesting to update the PIN information is sent to the first network function after the predetermined event of the first PINE is triggered, the PIN information can be updated in time when the predetermined event is triggered.

### BRIEF DESCRIPTION OF THE DRAWINGS

The accompanying drawings, which are incorporated in and constitute a part of this specification, illustrate embodiments consistent with the present disclosure and together with the specification serve to explain principles of embodiments of the present disclosure.

FIG. 1 is a schematic structural diagram illustrating a wireless communication system according to an exemplary embodiment.

FIG. 2 is a schematic flowchart illustrating a method for updating PIN information according to an exemplary embodiment.

FIG. 3 is a schematic flowchart illustrating a method for updating PIN information according to an exemplary embodiment.

FIG. 4 is a schematic flowchart illustrating a method for updating PIN information according to an exemplary embodiment.

FIG. 5 is a schematic flowchart illustrating a method for updating PIN information according to an exemplary embodiment.

FIG. 6 is a schematic flowchart illustrating a method for updating PIN information according to an exemplary embodiment.

FIG. 7 is a schematic flowchart illustrating a method for updating PIN information according to an exemplary embodiment.

FIG. 8 is a schematic flowchart illustrating a method for updating PIN information according to an exemplary embodiment.

FIG. 9 is a schematic flowchart illustrating a method for updating PIN information according to an exemplary embodiment.

FIG. 10 is a schematic flowchart illustrating a method for updating PIN information according to an exemplary embodiment.

FIG. 11 is a schematic flowchart illustrating a method for updating PIN information according to an exemplary embodiment.

FIG. 12 is a schematic flowchart illustrating a method for updating PIN information according to an exemplary embodiment.

FIG. 13 is a schematic structural diagram illustrating an apparatus for updating PIN information according to an exemplary embodiment.

FIG. 14 is a schematic structural diagram illustrating an apparatus for updating PIN information according to an exemplary embodiment.

FIG. 15 is a schematic structural diagram illustrating an apparatus for updating PIN information according to an exemplary embodiment.

FIG. 16 is a schematic structural diagram illustrating an apparatus for updating PIN information according to an exemplary embodiment.

FIG. 17 is a schematic structural diagram of a terminal according to an exemplary embodiment.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to embodiments of the present disclosure as recited in the appended claims.

Terms used in embodiments of the present disclosure are for describing some embodiments only, and are not intended to limit the embodiments of the present disclosure. As used in embodiments of the present disclosure and the appended claims, “a/an” and “the” in singular forms are also intended to include plural forms unless the context clearly indicates otherwise. It could also be understood that the term “and/or” as used herein refers to and includes any and all possible combinations of one or more associated listed items.

It could be understood that although the embodiments of the present disclosure may use the terms “first”, “second”, “third”, and the like, to describe various information, but the information is not limited to these terms. These terms are only used to distinguish information of the same type from each other. For example, without departing from the scope of embodiments of the present disclosure, first information may also be called second information, and similarly second information may also be called first information. Depending on the context, the words “if” and “whether” as used herein may be interpreted as “upon” or “when” or “in response to determining”.

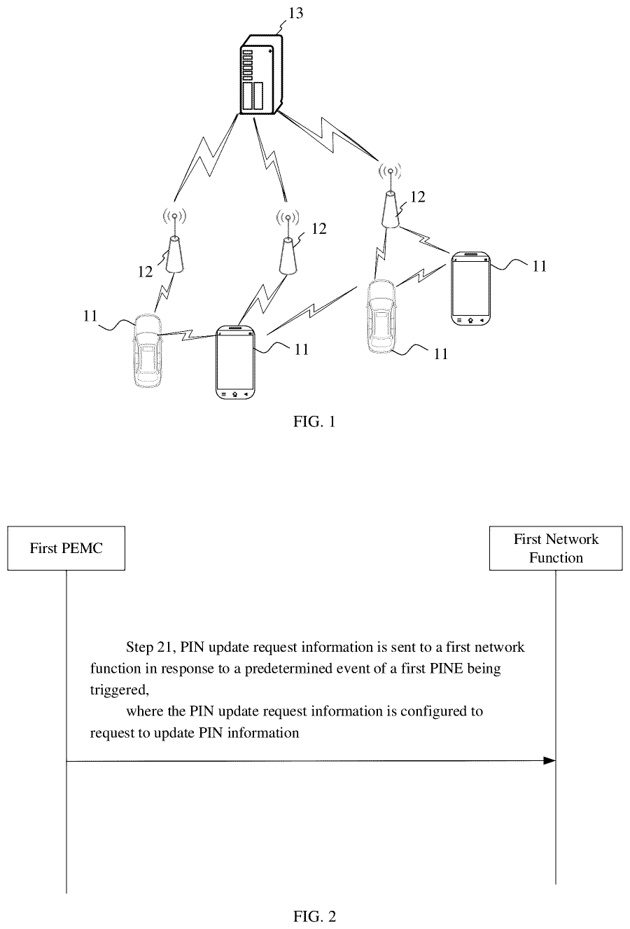

Referring to FIG. 1, FIG. 1 is a schematic structural diagram illustrating a wireless communication system according to an exemplary embodiment. As shown in FIG. 1, the wireless communication system is a communication system based on a cellular mobile communication technology, and the wireless communication system can include a plurality of terminals 11 and a plurality of base stations 12.

The terminal 11 may be a device that provides voice and/or data connectivity to a user. The terminal 11 may communicate with one or more core networks via a radio access network (RAN). The terminal 11 may be an Internet of Things terminal, for example, a sensor device, a mobile phone (or called a “cellular” phone) and a computer having an Internet of Things terminal. For example, the terminal 11 may be a fixed, portable, pocket, hand-held, built-in computer or vehicle-mounted device. For example, the terminal 11 may be a station (STA), a subscriber unit, a subscriber station, a mobile station, a mobile, a remote station, an access point, a remote terminal, an access terminal, a user terminal, a user agent, a user device, or a user equipment (UE). Alternatively, the terminal 11 may be a device of an unmanned aerial vehicle. Alternatively, the terminal 11 may be a vehicle-mounted device, for example, a trip computer with a wireless communication function, or a wireless communication device externally connected to the trip computer. Alternatively, the terminal 11 may also be a roadside device, for example, it may be a street lamp, a signal lamp, or other roadside devices with a wireless communication function.

The base station 12 may be a network side device in a wireless communication system. The wireless communication system may be the fourth generation mobile communication technology (4G) system, also known as a long term evolution (LTE) system. Alternatively, the wireless communication system may also be the fifth generation mobile communication technology (5G) system, also called a new radio (NR) system or 5G NR system. Alternatively, the wireless communication system may also be any generation system. An access network in the 5G system may be called a new generation-radio access network (NG-RAN). Alternatively, the wireless communication system may also be a machine type communication (MTC) system.

The base station 12 may be an evolved base station (eNB) adopted in a 4G system. Alternatively, the base station 12 may also be a central distributed architecture base station (gNB) in the 5G system. When the base station 12 adopts a central distributed architecture, the base station 12 generally includes a central unit (CU) and at least two distributed units (DU). The central unit is provided with a protocol stack of a packet data convergence protocol (PDCP) layer, a radio link control (RLC) layer, or a media access control (MAC) layer. A protocol stack of a physical (PHY) layer is provided in the distributed unit. The specific implementation manner of the base station 12 is not limited in the embodiments of the present disclosure.

A wireless connection may be established between the base station 12 and the terminal 11 through a wireless air interface. In some embodiments, the wireless air interface is a wireless air interface based on the fourth generation mobile communication network technology (4G) standard. Alternatively, the wireless air interface is a wireless air interface based on the fifth generation mobile communication network technology (5G) standard. For example, the wireless air interface is a new radio. Alternatively, the wireless air interface may also be a wireless air interface based on a next generation mobile communication network technology standard based on 5G.

In some embodiments, an E2E (end to end) connection may also be established between terminals 11, for example, a V2V (vehicle to vehicle) communication, a V2I (vehicle to infrastructure) communication and a V2P (vehicle to pedestrian) communication in vehicle to everything (V2X) communication scenes.

In some embodiments, the above-mentioned wireless communication system may further include a network management device 13.

Execution subjects involved in the embodiments of the present disclosure include, but are not limited to, terminals (the user equipment, UE) in cellular mobile communication systems, and base stations of the cellular mobile communication.

In order to better understand the embodiments of the present disclosure, application scenarios of wireless communication of PIN will be described below.

In one embodiment, in order to support necessary procedures regarding to a PIN, for example, a communication between PIN elements (PINEs), PINE discovery, PIN element with gateway capability (PEGC) discovery, PIN element with management capability (PEMC) discovery, an authorization for the PINE, an authorization for the PEGC and/or an authorization of the PEMC, and necessary policies and/or parameter configurations are needed. Related technologies include: 1. whether and how the PIN related policies and parameters identified in other KIs for PIN discovery, the PINE discovery, the authentication and/or authorization for PINE and PIN communication are configured to the PEMC, PEGC and/or PINE; 2. whether and how a core network supports provisioning of configuration information to the PEGC for access control.

As shown in FIG. 2, an embodiment of the present disclosure provides a method for updating personal IoT network (PIN) information. The method is executed by a first PEMC and includes:
step 21, it is determined that a predetermined event of a first PIN element (PINE) is triggered, and PIN update request information is sent to a first network function,
where the PIN update request information is configured to request to update PIN information.

Here, the PINE involved in the present disclosure can be an element in a PIN, and the PINE can be a normal PIN element, a PEGC or a PEMC, where the normal PIN element can be a PIN element without gateway capability and management capability. It should be noted that the PIN can include at least one PEGC and at least one PEMC.

Here, the PIN element can be a terminal. The terminal involved in the present disclosure can be, but is not limited to, mobile phones, a wearable device, a vehicle terminal, a road side unit (RSU), a smart home terminal, an industrial sensing device and/or a medical device. In some embodiments, the terminal may be a Redcap terminal or a new air interface (NR) terminal of a predetermined version (for example, an NR terminal of R17).

The base station involved in the present disclosure can be various types of base stations, for example, a base station of a fifth generation mobile communication (5G) network or other evolved base stations.

The network function involved in the present disclosure can be various types of network functions, for example, a network function of the fifth generation mobile communication (5G) network or other evolved network functions. The network function can be an access and mobility management function (AMF), a PIN management function (PMF), a unified data management (UDM) function, and the like.

In one embodiment, the first network function is the AMF. Each PINE can be associated with an AMF. The AMF associated with the PINE is an AMF serving the PINE.

In one embodiment, after the predetermined event is triggered, it is necessary to update the PIN to ensure normal communication of the PIN. The predetermined event can include at least one of the following: a valid time of the PINE expires; a PINE is added to a PIN; the PINE leaves the PIN; the PINE in the PIN is updated; the valid time of the PINE is updated; PIN policies are updated; PIN configuration parameters are updated; or a capability of the PINE is updated. In response to the update of the PIN, the PIN information needs to be updated. The updated PIN information can include at least one of the following: information that the valid time of the PINE has expired; information that the PINE has been added to the PIN; information that the PINE has left the PIN; information that the PINE in the PIN has been updated; information that the valid time of the PINE has been updated; information that the PIN policies have been updated; information that the PIN configuration parameters have updated; or information that the capability of the PINE has been updated. Of course, the updated PIN information is not limited to the above examples, but can also include other information of the PINE, for example, power consumption information of the PINE.

In one embodiment, the PIN update request information is sent to the first network function in response to the predetermined event of the first PINE being triggered, where the PIN update request information is configured to request to update PIN information. The predetermined event includes at least one of: a valid time of the PINE expires; a PINE is added to a PIN; the PINE leaves the PIN; the PINE in the PIN is updated; the valid time of the PINE is updated; PIN policies are updated; PIN configuration parameters are updated; or a capability of the PINE is updated (for example, a capability of having Bluetooth function).

In one embodiment, the PIN update request information is sent to the AMF associated with the first PINE in response to the predetermined event of the first PINE being triggered, where the PIN update request information is configured to request to update PIN information.

In one embodiment, the PIN update request information is sent to the first network function in response to the predetermined event of the first PINE being triggered, where the PIN update request information includes updated PIN information and/or PINE information. It should be noted that the updated PIN information and/or PINE information can include at least one of the following: information that the valid time of the PINE has expired; information that the PINE has been added to the PIN; information that the PINE has left the PIN; information that the PINE in the PIN has been updated; information that the valid time of the PINE has been updated; information that the PIN policies have been updated; information that the PIN configuration parameters have updated; or information that the capability of the PINE has been updated.

In one embodiment, the PIN update request information is sent to the first network function in response to the predetermined event of the first PINE being triggered, where the PIN update request information is configured to request to update PIN information. PIN update response information sent by the first network function is received, where the PIN update response information indicates whether the PIN information is successfully updated.

In one embodiment, the PIN update request information is sent to the first network function in response to the predetermined event of the first PINE being triggered, where the PIN update request information is configured to request to update PIN information. Updated PIN information is sent to a second PINE. It should be noted that the second PINE may be different from the first PINE or the first PINE.

In one embodiment, the PIN update request information is sent to the first network function in response to the predetermined event of the first PINE being triggered, where the PIN update request information is configured to request to update PIN information. PIN update response information sent by the first network function is received, where the PIN update response information indicates that the PIN information is successfully updated. The updated PIN information is sent to the second PINE.

In one embodiment, the PIN update request information is sent to the first network function in response to the predetermined event of the first PINE being triggered, where the PIN update request information is configured to request to update PIN information. The updated PIN information is sent to the second PINE, where the second PINE is an element impacted by the update to the PIN information.

It should be noted that the PINE is impacted by the update to the PIN information may be that information on which the PINE function depends needs to be updated synchronously with the update of the PIN information. For example, the PEGC is a gateway of the PINE, the PIN information will be updated after the PEGC leaves the PIN, and thus it is necessary for the PINE to obtain the information that the PEGC leaves the PIN. In this scenario, the PINE is a PINE impacted by the update to the PIN information.

In one embodiment, the first PINE or the second PINE includes at least one of: a PIN element with gateway capability (PEGC); a PIN element with management capability (PEMC); or a PIN element without gateway capability and management capability.

In the embodiments of the present disclosure, the PIN update request information is sent to the first network function in response to the predetermined event of the first PINE being triggered, where the PIN update request information is configured to request to update PIN information. Here, since the PIN update request information for requesting to update the PIN information is sent to the first network function after the predetermined event of the first PINE is triggered, the PIN information can be updated in time when the predetermined event is triggered.

It should be noted that a person skilled in the art can understand that the methods provided in the embodiments of the present disclosure can be executed alone or together with some methods in the embodiments of the present disclosure or some methods in the related art.

As shown in FIG. 3, an embodiment of the present disclosure provides a method for updating personal IoT network (PIN) information. The method is executed by a first PEMC and includes:
step 31, PIN update response information sent by the first network function is received,
where the PIN update response information indicates whether the PIN information is successfully updated.

In one embodiment, the first network function may be the AMF.

In one embodiment, the PIN update request information is sent to the first network function in response to the predetermined event of the first PINE being triggered, where the PIN update request information is configured to request to update PIN information. PIN update response information sent by the first network function is received, where the PIN update response information indicates whether the PIN information is successfully updated.

In one embodiment, the PIN update request information is sent to the first network function in response to the predetermined event of the first PINE being triggered, where the PIN update request information is configured to request to update PIN information. PIN update response information sent by the first network function is received, where the PIN update response information indicates that the PIN information is successfully updated. The updated PIN information is sent to the second PINE.

The predetermined event includes at least one of: a valid time of the PINE expires; a PINE is added to a PIN; the PINE leaves the PIN; the PINE in the PIN is updated; the valid time of the PINE is updated; PIN policies are updated; PIN configuration parameters are updated; or a capability of the PINE is updated.

It should be noted that a person skilled in the art can understand that the methods provided in the embodiments of the present disclosure can be executed alone or together with some methods in the embodiments of the present disclosure or some methods in the related art.

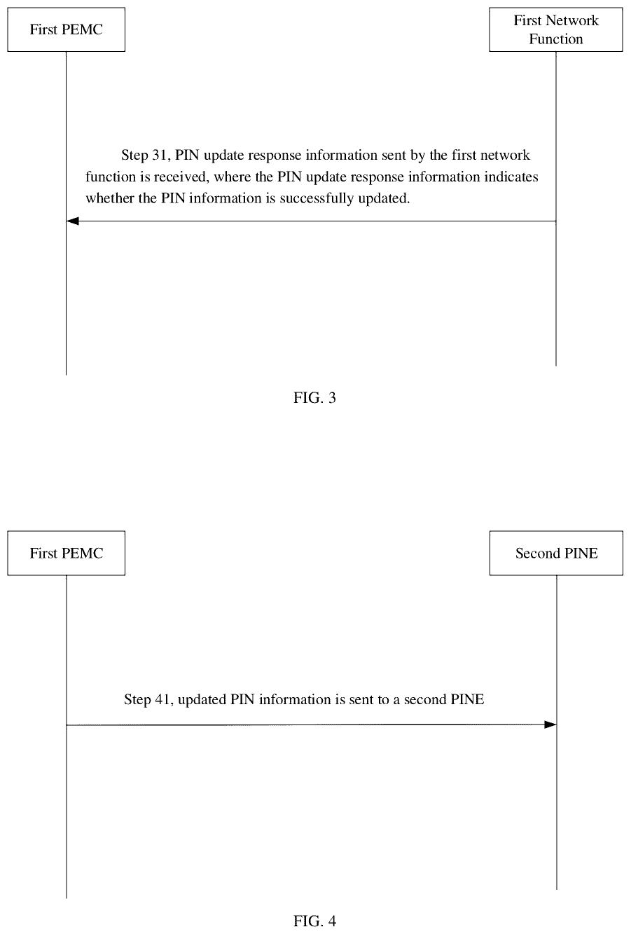

As shown in FIG. 4, an embodiment of the present disclosure provides a method for updating personal IoT network (PIN) information. The method is executed by a first PEMC and includes:
step 41, updated PIN information is sent to a second PINE.

In one embodiment, the updated PIN information is sent to the second PINE in response to the predetermined event of the first PINE being triggered.

In one embodiment, the PIN update request information is sent to the first network function in response to the predetermined event of the first PINE being triggered, where the PIN update request information is configured to request to update PIN information. PIN update response information sent by the first network function is received, where the PIN update response information indicates that the PIN information is successfully updated. The updated PIN information is sent to the second PINE.

The predetermined event includes at least one of: a valid time of the PINE expires; a PINE is added to a PIN; the PINE leaves the PIN; the PINE in the PIN is updated; the valid time of the PINE is updated; PIN policies are updated; PIN configuration parameters are updated; or a capability of the PINE is updated.

It should be noted that a person skilled in the art can understand that the methods provided in the embodiments of the present disclosure can be executed alone or together with some methods in the embodiments of the present disclosure or some methods in the related art.

As shown in FIG. 5, an embodiment of the present disclosure provides a method for updating personal IoT network (PIN) information. The method is executed by a first network function and includes:
step 51, PIN update request information sent by a first PEMC is received,
where the PIN update request information is configured to request to update PIN information.

Here, the PINE involved in the present disclosure can be an element in a PIN, and the PINE can be a normal PIN element, a PEGC or a PEMC, where the normal PIN element can be a PIN element without gateway capability and management capability. It should be noted that the PIN can include at least one PEGC and at least one PEMC.

Here, the PIN element can be a terminal. The terminal involved in the present disclosure can be, but is not limited to, mobile phones, a wearable device, a vehicle terminal, a road side unit (RSU), a smart home terminal, an industrial sensing device and/or a medical device. In some embodiments, the terminal may be a Redcap terminal or a new air interface (NR) terminal of a predetermined version (for example, an NR terminal of R17).

The base station involved in the present disclosure can be various types of base stations, for example, a base station of a fifth generation mobile communication (5G) network or other evolved base stations.

The network function involved in the present disclosure can be various types of network functions, for example, a network function of the fifth generation mobile communication (5G) network or other evolved network functions. The network function can be an access and mobility management function (AMF), a PIN management function (PMF), a unified data management (UDM) function, and the like.

In one embodiment, the first network function is the AMF. Each PINE can be associated with an AMF. The AMF associated with the PINE is an AMF serving the PINE.

In one embodiment, the first network function is the AMF, the second network function is the UDM function, and the third network function is the PMF.

In one embodiment, after the predetermined event is triggered, it is necessary to update the PIN to ensure normal communication of the PIN. The predetermined event can include at least one of the following: a valid time of the PINE expires; a PINE is added to a PIN; the PINE leaves the PIN; the PINE in the PIN is updated; the valid time of the PINE is updated; PIN policies are updated; PIN configuration parameters are updated; or a capability of the PINE is updated. In response to the update of the PIN, the PIN information needs to be updated. The updated PIN information can include at least one of the following: information that the valid time of the PINE has expired; information that the PINE has been added to the PIN; information that the PINE has left the PIN; information that the PINE in the PIN has been updated; information that the valid time of the PINE has been updated; information that the PIN policies have been updated; information that the PIN configuration parameters have updated; or information that the capability of the PINE has been updated. Of course, the updated PIN information is not limited to the above examples, but can also include other information of the PINE, for example, power consumption information of the PINE.

In one embodiment, PIN update request information sent by a first PEMC is received, where the PIN update request information is configured to request to update PIN information. The predetermined event includes at least one of: a valid time of the PINE expires; a PINE is added to a PIN; the PINE leaves the PIN; the PINE in the PIN is updated; the valid time of the PINE is updated; PIN policies are updated; PIN configuration parameters are updated; or a capability of the PINE is updated.

In one embodiment, PIN update request information sent by a first PEMC is received, where the PIN update request information includes updated PIN information and/or PINE information. It should be noted that the updated PIN information and/or PINE information can include at least one of the following: information that the valid time of the PINE has expired; information that the PINE has been added to the PIN; information that the PINE has left the PIN; information that the PINE in the PIN has been updated; information that the valid time of the PINE has been updated; information that the PIN policies have been updated; information that the PIN configuration parameters have updated; or information that the capability of the PINE has been updated.

In one embodiment, PIN update request information sent by a first PEMC is received, where the PIN update request information is configured to request to update PIN information. The PIN update request information is sent to the second network function. Here, the second network function may be the UDM function.

In one embodiment, PIN update request information sent by a first PEMC is received, where the PIN update request information is configured to request to update PIN information. The PIN update request information is sent to the third network function. Here, the third network function may be the PMF.

In one embodiment, PIN update request information sent by a first PEMC is received, where the PIN update request information is configured to request to update PIN information. The PIN update request information is sent to the second network function or the third network function. PIN update response information sent by the second network function or the third network function is received, where the PIN update response information indicates whether the PIN information is successfully updated; and the PIN update response information is sent to the first PEMC.

It should be noted that a person skilled in the art can understand that the methods provided in the embodiments of the present disclosure can be executed alone or together with some methods in the embodiments of the present disclosure or some methods in the related art.

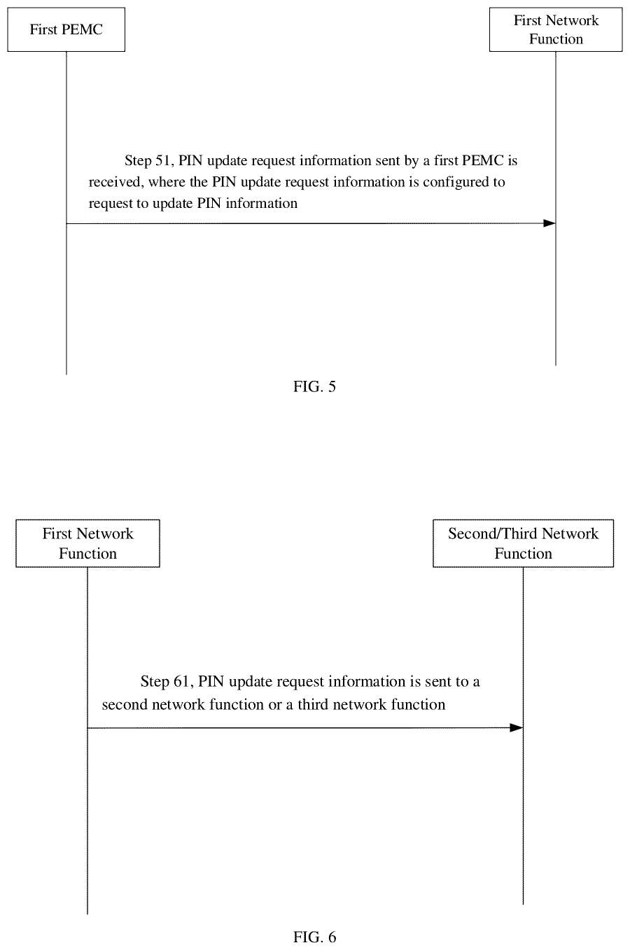

As shown in FIG. 6, an embodiment of the present disclosure provides a method for updating personal IoT network (PIN) information. The method is executed by a first network function and includes:
step 61, the PIN update request information is sent to a second network function or a third network function.

In one embodiment, the first network function is the AMF, the second network function is the UDM function, and the third network function is the PMF.

In one embodiment, PIN update request information sent by a first PEMC is received, where the PIN update request information is configured to request to update PIN information. The PIN update request information is sent to the second network function. Here, the second network function may be the UDM function.

In one embodiment, PIN update request information sent by a first PEMC is received, where the PIN update request information is configured to request to update PIN information. The PIN update request information is sent to the third network function. Here, the third network function may be the PMF.

In one embodiment, PIN update request information sent by a first PEMC is received, where the PIN update request information includes updated PIN information and/or PINE information. It should be noted that the updated PIN information and/or PINE information can include at least one of the following: information that the valid time of the PINE has expired; information that the PINE has been added to the PIN; information that the PINE has left the PIN; information that the PINE in the PIN has been updated; information that the valid time of the PINE has been updated; information that the PIN policies have been updated; information that the PIN configuration parameters have updated; or information that the capability of the PINE has been updated. The PIN update request information is sent to the second network function or the third network function.

It should be noted that a person skilled in the art can understand that the methods provided in the embodiments of the present disclosure can be executed alone or together with some methods in the embodiments of the present disclosure or some methods in the related art.

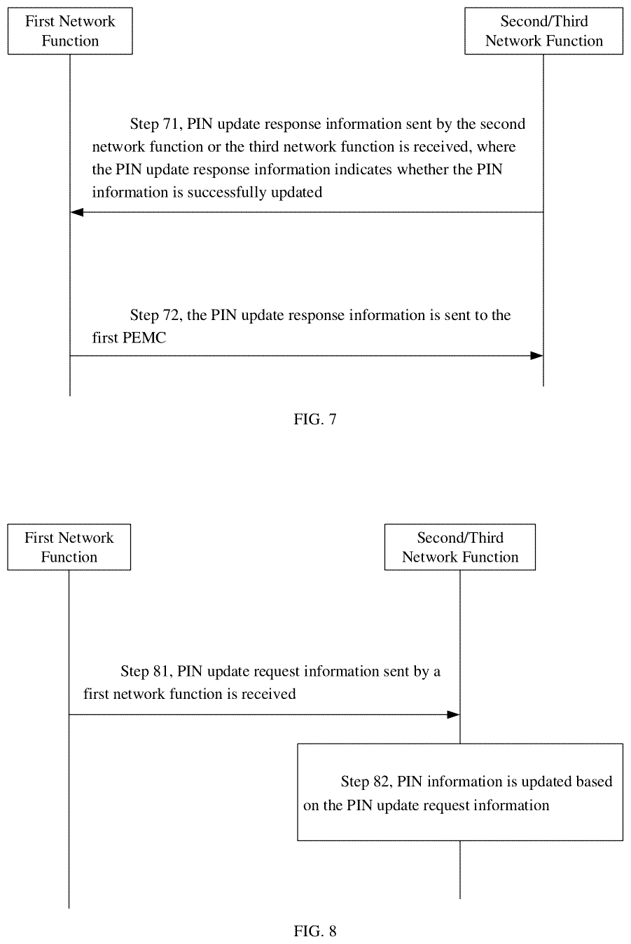

As shown in FIG. 7, an embodiment of the present disclosure provides a method for updating personal IoT network (PIN) information. The method is executed by a first network function and includes:
step 71, PIN update response information sent by the second network function or the third network function is received, where the PIN update response information indicates whether the PIN information is successfully updated; and
step 72, the PIN update response information is sent to the first PEMC.

In one embodiment, the first network function is the AMF, the second network function is the UDM function, and the third network function is the PMF.

In one embodiment, PIN update request information sent by a first PEMC is received, where the PIN update request information is configured to request to update PIN information. The PIN update request information is sent to the second network function or the third network function. PIN update response information sent by the second network function or the third network function is received, where the PIN update response information indicates whether the PIN information is successfully updated; and the PIN update response information is sent to the first PEMC.

It should be noted that a person skilled in the art can understand that the methods provided in the embodiments of the present disclosure can be executed alone or together with some methods in the embodiments of the present disclosure or some methods in the related art.

As shown in FIG. 8, an embodiment of the present disclosure provides a method for updating personal IoT network (PIN) information. The method is executed by a second network function or a third network function and includes:
step 81, PIN update request information sent by a first network function is received; and
step 82, PIN information is updated based on the PIN update request information.

Here, the PINE involved in the present disclosure can be an element in a PIN, and the PINE can be a normal PIN element, a PEGC or a PEMC, where the normal PIN element can be a PIN element without gateway capability and management capability. It should be noted that the PIN can include at least one PEGC and at least one PEMC.

Here, the PIN element can be a terminal. The terminal involved in the present disclosure can be, but is not limited to, mobile phones, a wearable device, a vehicle terminal, a road side unit (RSU), a smart home terminal, an industrial sensing device and/or a medical device. In some embodiments, the terminal may be a Redcap terminal or a new air interface (NR) terminal of a predetermined version (for example, an NR terminal of R17).

The base station involved in the present disclosure can be various types of base stations, for example, a base station of a fifth generation mobile communication (5G) network or other evolved base stations.

The network function involved in the present disclosure can be various types of network functions, for example, a network function of the fifth generation mobile communication (5G) network or other evolved network functions. The network function can be an access and mobility management function (AMF), a PIN management function (PMF), a unified data management (UDM) function, and the like.

In one embodiment, the first network function is the AMF. Each PINE can be associated with an AMF. The AMF associated with the PINE is an AMF serving the PINE.

In one embodiment, the first network function is the AMF, the second network function is the UDM function, and the third network function is the PMF.

In one embodiment, after the predetermined event is triggered, it is necessary to update the PIN to ensure normal communication of the PIN. The predetermined event can include at least one of the following: a valid time of the PINE expires; a PINE is added to a PIN; the PINE leaves the PIN; the PINE in the PIN is updated; the valid time of the PINE is updated; PIN policies are updated; PIN configuration parameters are updated; or a capability of the PINE is updated. In response to the update of the PIN, the PIN information needs to be updated. The updated PIN information can include at least one of the following: information that the valid time of the PINE has expired; information that the PINE has been added to the PIN; information that the PINE has left the PIN; information that the PINE in the PIN has been updated; information that the valid time of the PINE has been updated; information that the PIN policies have been updated; information that the PIN configuration parameters have updated; or information that the capability of the PINE has been updated. Of course, the updated PIN information is not limited to the above examples, but can also include other information of the PINE, for example, power consumption information of the PINE.

In one embodiment, the first network function is the AMF, the second network function is the UDM function, and the third network function is the PMF.

In one embodiment, PIN update request information sent by a first network function is received, where the PIN update request information includes updated PIN information and/or PINE information. It should be noted that the updated PIN information and/or PINE information can include at least one of the following: information that the valid time of the PINE has expired; information that the PINE has been added to the PIN; information that the PINE has left the PIN; information that the PINE in the PIN has been updated; information that the valid time of the PINE has been updated; information that the PIN policies have been updated; information that the PIN configuration parameters have updated; or information that the capability of the PINE has been updated.

In one embodiment, PIN update request information sent by a first network function is received, and PIN information is updated based on the PIN update request information. For example, a PIN profile is updated based on the PIN update request information.

In one embodiment, PIN update request information sent by a first network function is received, and PIN information is updated based on the PIN update request information. It is determined whether to notify the second PINE; and a PIN update notification program is started in response to determining to notify the second PINE. The second PINE is an element impacted by the update to the PIN information.

In one embodiment, PIN update request information sent by a first network function is received, PIN information is updated based on the PIN update request information; and the PIN update response information is sent to the first network function, where the PIN update response information indicates whether the PIN information is successfully updated. Here, in response to the PIN information being successfully updated, the PIN update response information indicates that the PIN information is successfully updated; alternatively, in response to the PIN information not being successfully updated, the PIN update response information indicates that the PIN information is not successfully updated.

It should be noted that a person skilled in the art can understand that the methods provided in the embodiments of the present disclosure can be executed alone or together with some methods in the embodiments of the present disclosure or some methods in the related art.

As shown in FIG. 9, an embodiment of the present disclosure provides a method for updating personal IoT network (PIN) information. The method is executed by a second network function or a third network function and includes:
step 91, it is determined whether to notify the second PINE; and
step 92, a PIN update notification program is started in response to determining to notify the second PINE.

In one embodiment, the first network function is the AMF, the second network function is the UDM function, and the third network function is the PMF.

In one embodiment, PIN update request information sent by a first network function is received, and PIN information is updated based on the PIN update request information. It is determined whether to notify the second PINE; and a PIN update notification program is started in response to determining to notify the second PINE. The second PINE is an element impacted by the update to the PIN information.

In one embodiment, the second PINE is an element impacted by the update to the PIN information.

It should be noted that the PINE is impacted by the update to the PIN information may be that information on which the PINE function depends needs to be updated synchronously with the update of the PIN information. For example, the PEGC is a gateway of the PINE, the PIN information will be updated after the PEGC leaves the PIN, and thus it is necessary for the PINE to obtain the information that the PEGC leaves the PIN. In this scenario, the PINE is a PINE impacted by the update to the PIN information.

It should be noted that a person skilled in the art can understand that the methods provided in the embodiments of the present disclosure can be executed alone or together with some methods in the embodiments of the present disclosure or some methods in the related art.

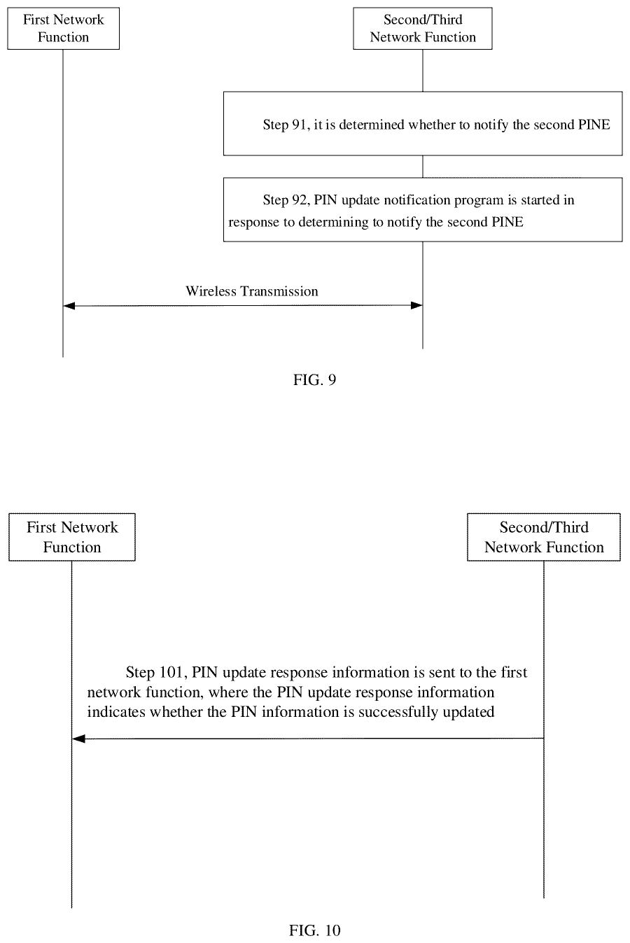

As shown in FIG. 10, an embodiment of the present disclosure provides a method for updating personal IoT network (PIN) information. The method is executed by a second network function or a third network function and includes:
step 101, PIN update response information is sent to the first network function,
where the PIN update response information indicates whether the PIN information is successfully updated.

In one embodiment, the first network function is the AMF, the second network function is the UDM function, and the third network function is the PMF.

In one embodiment, PIN update request information sent by a first network function is received, PIN information is updated based on the PIN update request information; and the PIN update response information is sent to the first network function, where the PIN update response information indicates whether the PIN information is successfully updated. Here, in response to the PIN information being successfully updated, the PIN update response information indicates that the PIN information is successfully updated; alternatively, in response to the PIN information not being successfully updated, the PIN update response information indicates that the PIN information is not successfully updated.

It should be noted that a person skilled in the art can understand that the methods provided in the embodiments of the present disclosure can be executed alone or together with some methods in the embodiments of the present disclosure or some methods in the related art.

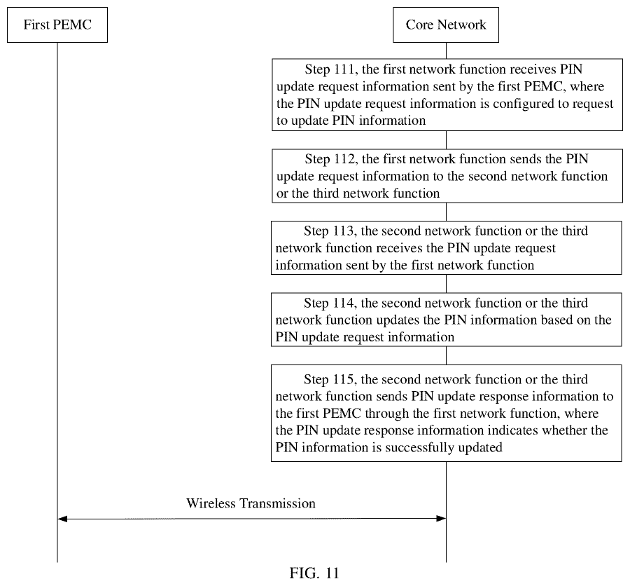

As shown in FIG. 11, an embodiment of the present disclosure provides a method for updating personal IoT network (PIN) information. The method is executed by a core network and includes:
step 111, the first network function receives PIN update request information sent by the first PEMC, where the PIN update request information is configured to request to update PIN information;
step 112, the first network function sends the PIN update request information to the second network function or the third network function;
step 113, the second network function or the third network function receives the PIN update request information sent by the first network function;
step 114, the second network function or the third network function updates the PIN information based on the PIN update request information; and
step 115, the second network function or the third network function sends PIN update response information to the first PEMC through the first network function, where the PIN update response information indicates whether the PIN information is successfully updated.

Here, the PINE involved in the present disclosure can be an element in a PIN, and the PINE can be a normal PIN element, a PEGC or a PEMC, where the normal PIN element can be a PIN element without gateway capability and management capability. It should be noted that the PIN can include at least one PEGC and at least one PEMC.

Here, the PIN element can be a terminal. The terminal involved in the present disclosure can be, but is not limited to, mobile phones, a wearable device, a vehicle terminal, a road side unit (RSU), a smart home terminal, an industrial sensing device and/or a medical device. In some embodiments, the terminal may be a Redcap terminal or a new air interface (NR) terminal of a predetermined version (for example, an NR terminal of R17).

The base station involved in the present disclosure can be various types of base stations, for example, a base station of a fifth generation mobile communication (5G) network or other evolved base stations.

The network function involved in the present disclosure can be various types of network functions, for example, a network function of the fifth generation mobile communication (5G) network or other evolved network functions. The network function can be an access and mobility management function (AMF), a PIN management function (PMF), a unified data management (UDM) function, and the like.

In one embodiment, the first network function is the AMF. Each PINE can be associated with an AMF. The AMF associated with the PINE is an AMF serving the PINE.

In one embodiment, the first network function is the AMF, the second network function is the UDM function, and the third network function is the PMF.

It should be noted that a person skilled in the art can understand that the methods provided in the embodiments of the present disclosure can be executed alone or together with some methods in the embodiments of the present disclosure or some methods in the related

In order to better understand technical solutions of the present disclosure, the technical solutions of the present disclosure will be further explained through an exemplary embodiment.

### EXAMPLE 1

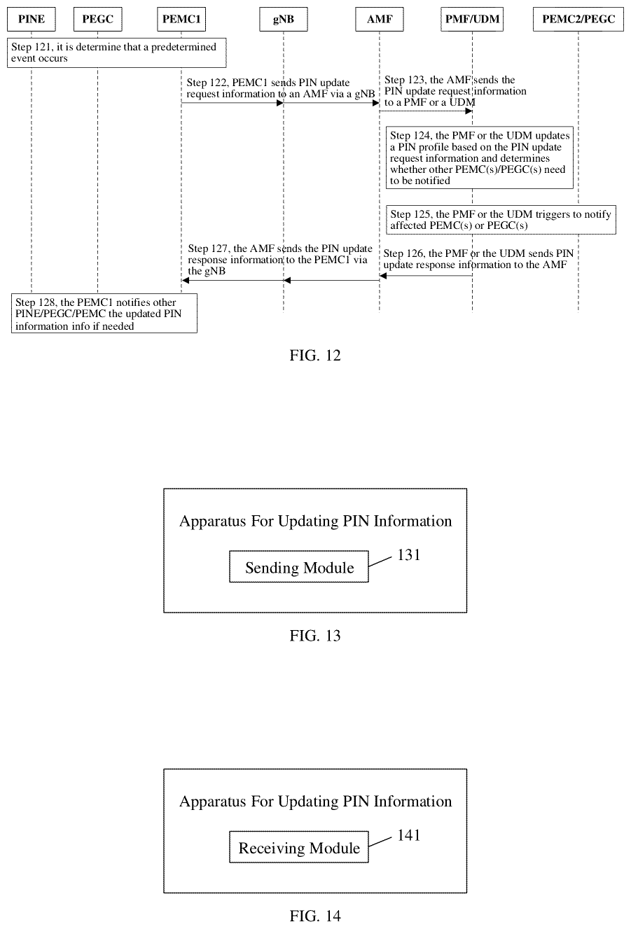

Referring to FIG. 12, an embodiment of the present disclosure provides a method for updating personal IoT network (PIN) information. The method includes following steps:
step 121, it is determine that a predetermined event occurs, where the predetermined event includes at least one of: a valid time of the PINE expires; a PINE is added to a PIN; the PINE leaves the PIN; the PINE in the PIN is updated; the valid time of the PINE is updated; PIN policies are updated; PIN configuration parameters are updated; or a capability of the PINE is updated;
step 122, a PEMC1 sends PIN update request information to an AMF via a gNB;
step 123, the AMF sends the PIN update request information to a PMF or a UDM, where the PIN update request information includes updated PIN/PINE information;
step 124, the PMF or the UDM updates a PIN profile based on the PIN update request information and determines whether other PEMC(s)/PEGC(s) need to be notified;
step 125, the PMF or the UDM triggers to notify impacted PEMC(s) or PEGC(s);
step 126, the PMF or the UDM sends PIN update response information to the AMF, where the PIN update response information indicates whether the PIN information is successfully updated;
step 127, the AMF sends the PIN update response information to the PEMC1 via the gNB; and
step 128, the PEMC1 notifies other PINE/PEGC/PEMC the updated PIN information info if needed.

It should be noted that a person skilled in the art can understand that the methods provided in the embodiments of the present disclosure can be executed alone or together with some methods in the embodiments of the present disclosure or some methods in the related art.

As shown in FIG. 13, an embodiment of the present disclosure provides an apparatus for updating personal IoT network (PIN) information, including: a sending module 131 configured to determine that a predetermined event of a first PIN element (PINE) is triggered, and send PIN update request information to a first network function, where the PIN update request information is configured to request to update PIN information.

It should be noted that a person skilled in the art can understand that the methods provided in the embodiments of the present disclosure can be executed alone or together with some methods in the embodiments of the present disclosure or some methods in the related art.

As shown in FIG. 14, an embodiment of the present disclosure provides an apparatus for updating personal IoT network (PIN) information, including: a receiving module 141 configured to receive PIN update request information sent by a first PIN element with management capability (PEMC), where the PIN update request information is configured to request to update PIN information.

It should be noted that a person skilled in the art can understand that the methods provided in the embodiments of the present disclosure can be executed alone or together with some methods in the embodiments of the present disclosure or some methods in the related art.

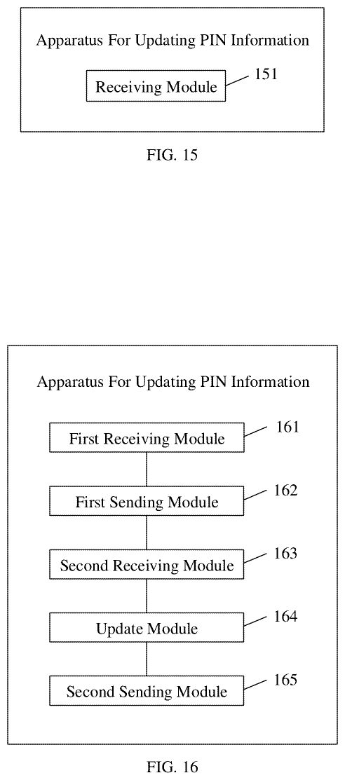

As shown in FIG. 15, an embodiment of the present disclosure provides an apparatus for updating personal IoT network (PIN) information, including: a receiving module 151 configured to receive PIN update request information sent by a first network function; and update PIN information based on the PIN update request information.

It should be noted that a person skilled in the art can understand that the methods provided in the embodiments of the present disclosure can be executed alone or together with some methods in the embodiments of the present disclosure or some methods in the related art.

As shown in FIG. 16, an embodiment of the present disclosure provides an apparatus for updating personal IoT network (PIN) information, including: a first receiving module 161 configured to receive, by a first network function, PIN update request information sent by a first PIN element with management capability (PEMC), where the PIN update request information is configured to request to update PIN information; a first sending module 162 configured to send, by the first network function, the PIN update request information to a second network function or a third network function; a second receiving module 163 configured to receive, by the second network function or the third network function, the PIN update request information sent by the first network function; an update module 164 configured to update, by the second network function or the third network function, the PIN information based on the PIN update request information; and a second sending module 165 configured to send, by the second network function or the third network function, PIN update response information to the first PEMC through the first network function, where the PIN update response information indicates whether the PIN information is successfully updated.

It should be noted that a person skilled in the art can understand that the methods provided in the embodiments of the present disclosure can be executed alone or together with some methods in the embodiments of the present disclosure or some methods in the related art.

An embodiment of the present disclosure provides a system for updating personal IoT network (PIN) information, including: a first network function and/or a second network function, where the first network function performs any one of the methods executed by the first network function in the present disclosure, and the second network function performs any one of the methods executed by the second network function in the present disclosure.

An embodiment of the present disclosure provides a communication device, including: a processor, and a memory configured to store processor-executable instructions; where the processor is configured to implement the method applied to any embodiment of the present disclosure when the processor-executable instructions are executed.

The processor can include various types of storage medium, which are non-transitory computer storage medium, and can continue to remember information stored on the communication device after the communication device is powered down.

The processor can be connected to the memory via a bus, and the like, and configured to read an executable program stored on the memory.

An embodiment of the present disclosure further provides a computer storage medium, where the computer storage medium stores a computer executable program, and the computer executable program, when executed by a processor, implements the method according to any embodiment of the present disclosure.

With regard to the apparatus in the above embodiment, the specific manner in which each module performs operations has been described in detail in the method embodiment, and will not be described in detail here.

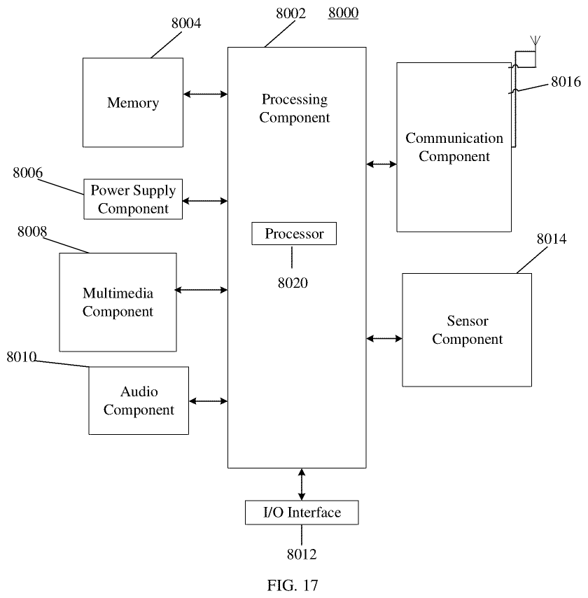

FIG. 17 is a block diagram illustrating a user equipment 8000 according to an exemplary embodiment. For example, the user equipment 8000 may be a mobile phone, a computer, a digital broadcast terminal, a messaging device, a game console, a tablet device, a medical device, a fitness device, a personal digital assistant, or the like.

Referring to FIG. 17, the user equipment 8000 can include one or more of the following components: a processing component 8002, a memory 8004, a power supply component 8006, a multimedia component 8008, an audio component 8010, an input/output (I/O) interface 8012, a sensor component 8014, and a communication component 8016.

The processing component 8002 generally controls the overall operations of user equipment 8000, for example, operations associated with display, phone calls, data communications, camera operations, and recording operations. The processing component 8002 can include one or more processors 8020 to execute instructions to complete all or part of the steps of the above-mentioned method. Additionally, the processing component 8002 can include one or more modules that facilitate interaction between the processing component 8002 and other components. For example, the processing component 8002 can include a multimedia module to facilitate interaction between the multimedia component 8008 and the processing component 8002.

The memory 8004 is configured to store various types of data to support operations at device 8000. Examples of such data include instructions for any application or method operating on the user equipment 8000, contact data, phonebook data, messages, pictures, videos, or the like. The memory 8004 may be implemented by any type of volatile or non-volatile storage device or a combination thereof, for example, static random-access memory (SRAM), electrically erasable programmable read-only memory (EEPROM), erasable Programmable read-only memory (EPROM), programmable read-only memory (PROM), read-only memory (ROM), magnetic memory, flash memory, magnetic or optical disk.

The power supply component 8006 provides power to various components of the user equipment 8000. The power supply components 8006 can include a power management system, one or more power supplies, and other components associated with generating, managing, and distributing power to the user equipment 8000.

The multimedia component 8008 includes a screen that provides an output interface between the user equipment 8000 and the user. In some embodiments, the screen can include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. A touch sensor can not only sense the boundaries of a touch or swipe action, but also detect the duration and pressure associated with the touch or swipe action. In some embodiments, the multimedia component 8008 includes a front camera and/or a rear camera. When the device 8000 is in an operating mode, for example, a shooting mode or a video mode, the front camera and/or the rear camera may receive external multimedia data. Each front camera and rear camera can be a fixed optical lens system or have a focal length and optical zoom capabilities.

The audio component 8010 is configured to output and/or input audio signals. For example, the audio component 8010 includes a microphone (MIC) configured to receive external audio signals when the user equipment 8000 is in operating modes, for example, call mode, recording mode, and speech recognition mode. The received audio signal may be further stored in the memory 8004 or sent via the communication component 8016. In some embodiments, the audio component 8010 also includes a speaker for outputting audio signals.

The I/O interface 8012 provides an interface between the processing component 8002 and a peripheral interface module. The peripheral interface module may be a keyboard, a click wheel, a button, or the like. These buttons can include but are not limited to home button, volume buttons, start button, and lock button.

The sensor component 8014 includes one or more sensors that provide various aspects of status assessment for the user equipment 8000. For example, the sensor component 8014 can detect the open/closed state of the device 8000, and the relative positioning of components, for example, the display and keypad of the user equipment 8000. The sensor component 8014 can also detect the position change in the user equipment 8000 or a component in the user equipment 8000, the presence or absence of user contact with the user equipment 8000, the orientation or acceleration/deceleration of the user equipment 8000 and temperature changes of the user equipment 8000. The sensor component 8014 can include a proximity sensor configured to detect the presence of nearby objects without any physical contact. The sensor component 8014 may also include a light sensor, for example, a complementary metal oxide semiconductor (CMOS) or a charge coupled device (CCD) image sensor, for use in imaging applications. In some embodiments, the sensor component 8014 may also include an acceleration sensor, a gyroscope sensor, a magnetic sensor, a pressure sensor, or a temperature sensor.

The communication component 8016 is configured to facilitate wired or wireless communication between the user equipment 8000 and other devices. The user equipment 8000 may access a wireless network based on a communication standard, for example, Wi-Fi, 2G or 3G, or a combination thereof. In an embodiment, the communication component 8016 receives broadcast signals or broadcast related information from an external broadcast management system via a broadcast channel. In an embodiment, the communication component 8016 also includes a near field communications (NFC) module to facilitate short-range communications. For example, the NFC module can be implemented based on radio frequency identification (RFID) technology, infrared data association (IrDA) technology, ultra-wideband (UWB) technology, Bluetooth (BT) technology and other technologies.

In an embodiment, the user equipment 8000 may be configured by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components to perform the steps of the above method for selecting the edge application server.

In an embodiment, a non-transitory computer-readable storage medium including instructions, for example, a memory 8004 including instructions, which can be executed by the processor 8020 of the user equipment 8000 to complete the steps of the above-mentioned method for selecting the edge application server is also provided. For example, non-transitory computer-readable storage media may be ROM, random access memory (RAM), CD-ROM, magnetic tape, floppy disk, optical data storage device, or the like.

Other embodiments of the present disclosure will be apparent to those skilled in the art from consideration of the specification and practice of the present disclosure disclosed here. The present disclosure is intended to cover any variations, uses, or adaptations of embodiments of the present disclosure following the general principles thereof and including such departures from embodiments of the present disclosure as come within known or customary practice in the art. It is intended that the specification and the examples be considered as illustrative only, with a true scope and spirit of the embodiments of the present disclosure being indicated by the following claims.

It is appreciated that embodiments of the present disclosure are not limited to the exact construction that has been described above and illustrated in the accompanying drawings, and that various modifications and changes may be made without departing from the scope thereof. It is intended that the scope of embodiments of the present disclosure only be limited by the appended claims.

1. A method for updating personal IoT network (PIN) information, executed by a first PIN element with management capability (PEMC), the method comprising:
determining that a predetermined event of a first PIN element (PINE) is triggered, and sending PIN update request information to a first network function,
wherein the PIN update request information is configured to request to update PIN information.

2. The method according to claim 1, wherein the predetermined event comprises at least one of:
a valid time of the PINE expires;
a PINE is added to a PIN;
the PINE leaves the PIN;
the PINE in the PIN is updated;
the valid time of the PINE is updated;
PIN policies are updated;
PIN configuration parameters are updated; or
a capability of the PINE is updated.

3. The method according to claim 1, wherein the first network function comprises an access and mobility management function (AMF).

4. The method according to claim 1, wherein the PIN update request information comprises at least one of updated PIN information and/or or PINE information.

5. The method according to claim 1, further comprising:
receiving PIN update response information sent by the first network function,
wherein the PIN update response information indicates whether the PIN information is successfully updated.

6. The method according to claim 1, further comprising:
sending updated PIN information to a second PINE.

7. (canceled)

8. The method according to claim 6, wherein the second PINE is an element impacted by the update to the PIN information.

9. A method for updating personal IoT network (PIN) information, executed by a first network function, the method comprising:
receiving PIN update request information sent by a first PIN element with management capability (PEMC),
wherein the PIN update request information is configured to request to update PIN information.

10. The method according to claim 9, further comprising:
sending the PIN update request information to a second network function or a third network function,
wherein the first network function comprises an access and mobility management function (AMF), the second network function comprises a unified data management (UDM) function, and the third network function comprises a PIN management function (PMF).

11. (canceled)

12. The method according to claim 9, further comprising:
receiving PIN update response information sent by a second network function or a third network function, wherein the PIN update response information indicates whether the PIN information is successfully updated; and
sending the PIN update response information to the first PEMC.

13. A method for updating personal IoT network (PIN) information, executed by a second network function or a third network function, the method comprising:
receiving PIN update request information sent by a first network function; and
updating PIN information based on the PIN update request information.

14. The method according to claim 13, wherein the first network function comprises an access and mobility management function (AMF), the second network function comprises a unified data management (UDM) function, and the third network function comprises a PIN management function (PMF).

15. The method according to claim 13, further comprising:
determining whether to notify a second PIN element (PINE); and
determining to notify the second PINE, and starting a PIN update notification program.

16. (canceled)

17. The method according to claim 13, further comprising:
sending PIN update response information to the first network function,
wherein the PIN update response information indicates whether the PIN information is successfully updated.

18.-25. (canceled)

26. A communication device, comprising:
a memory; and
one or more processors connected to the memory and configured to perform the method according to claim 1.

27. (canceled)

28. A communication device, comprising:
a memory; and
one or more processors, connected to the memory and configured to perform the method according to claim 9.

29. A communication device, comprising:
a memory; and
one or more processors, connected to the memory and configured to perform the method according to claim 13.

30. A non-transitory computer storage medium storing computer executable instructions that, when executed by a processor, cause the processor to perform the method according to claim 1.

31. A non-transitory computer storage medium storing computer executable instructions that, when executed by a processor, cause the processor to perform the method according to claim 9.

32. A non-transitory computer storage medium storing computer executable instructions that, when executed by a processor, cause the processor to perform the method according to claim 13.
